(19) United States
(12) Patent Application Publication
(10) Pub. No.: US 2015/0192960 A1
(43) Pub. Date: Jul. 9, 2015

(54) ELECTRONIC DEVICE SYSTEM WITH A CONFIGURABLE DISPLAY

(71) Applicants: Sameer SHARMA, (US); Hui WANG, (US); Deguo MIAO, Taipei (TW); INTEL CORPORATION, Santa Clara, CA (US)

(72) Inventors: Sameer Sharma, Santa Clara, CA (US); Hui Wang, Taipei (TW); Deguo Miao, Taipei (TW)

(21) Appl. No.: 14/126,694

(22) PCT Filed: Jun. 29, 2013
(86) PCT No.: PCT/US2013/048812

§ 371 Date: Dec. 16, 2013

(51) Int. Cl. G06F 1/16; G06F 3/14

(52) U.S. Cl. CPC G06F 1/1649; G06F 3/1438; G06F 1/162; G06F 1/1641

(57) ABSTRACT

Particular embodiments described herein provide for an electronic device, such as a notebook computer, laptop, or tablet that includes a circuit board coupled to a plurality of electronic components (which may include any type of components, elements, circuitry, etc.). One particular example implementation of the electronic device may include establishing an electrical coupling between a first portion of an electrical device and a second portion of the electrical device, where the first portion includes a first display and the second portion includes a second display. Removing the first portion from the second portion permits the first portion and the second portion to each operate as a standalone tablet device. The example implementation may also include initiating a collaboration session when the first portion is removed from the second portion.

### TECHNICAL FIELD

Embodiments described herein generally relate to configurable displays for an electronic device.

### BRIEF DESCRIPTION OF THE DRAWINGS

Embodiments are illustrated by way of example and not by way of limitation in the FIGURES of the accompanying drawings, in which like references indicate similar elements and in which:

FIG. 1A is a simplified orthographic view illustrating an embodiment of an electronic device in a closed clamshell configuration, in accordance with one embodiment of the present disclosure;

FIG. 1B is a simplified orthographic view illustrating an embodiment of an electronic device in an open clamshell configuration, in accordance with one embodiment of the present disclosure;

FIG. 1C is a simplified orthographic view illustrating an embodiment of an electronic device in a detached configuration, separated into two segments, in accordance with one embodiment of the present disclosure;

FIG. 1D is a simplified orthographic view illustrating an embodiment of an electronic device in a detached configuration, separated into two segments, in accordance with one embodiment of the present disclosure;

FIG. 2 is a simplified orthographic view illustrating an embodiment of an electronic device in accordance with one embodiment of the present disclosure;

FIG. 3 is a simplified orthographic view illustrating an embodiment of an electronic device in accordance with one embodiment of the present disclosure;

FIG. 4 is a simplified orthographic view illustrating an embodiment of an electronic device in a tablet configuration, in accordance with one embodiment of the present disclosure;

FIG. 5A is a simplified orthographic view illustrating an embodiment of an electronic device in a detached configuration, separated into two segments, in accordance with one embodiment of the present disclosure;

FIG. 5B is a simplified orthographic view illustrating an embodiment of an electronic device in a detached configuration, separated into two segments, in accordance with one embodiment of the present disclosure;

FIG. 5C is a simplified orthographic view illustrating an embodiment of an electronic device in a detached configuration, separated into two segments, in accordance with one embodiment of the present disclosure;

FIG. 6 is a simplified flow diagram illustrating potential operations associated with one embodiment of the present disclosure;

FIG. 7 is a simplified block diagram associated with an example ARM ecosystem system on chip (SOC) of the present disclosure; and

FIG. 8 is a simplified block diagram illustrating example logic that may be used to execute activities associated with the present disclosure.

The FIGURES of the drawings are not necessarily drawn to scale, as their dimensions can be varied considerably without departing from the scope of the present disclosure.

### DETAILED DESCRIPTION OF EXAMPLE EMBODIMENTS

The following detailed description sets forth example embodiments of apparatuses, methods, and systems relating to detachable display configurations for an electronic device. Features such as structure(s), function(s), and/or characteristic(s), for example, are described with reference to one embodiment as a matter of convenience; various embodiments may be implemented with any suitable one or more of the described features.

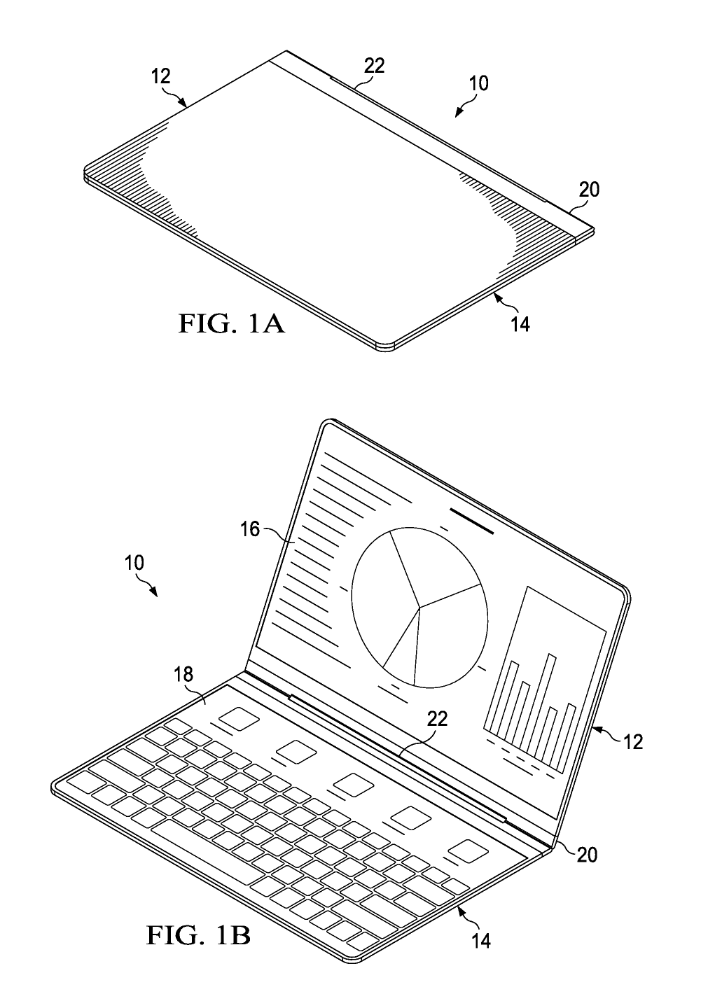

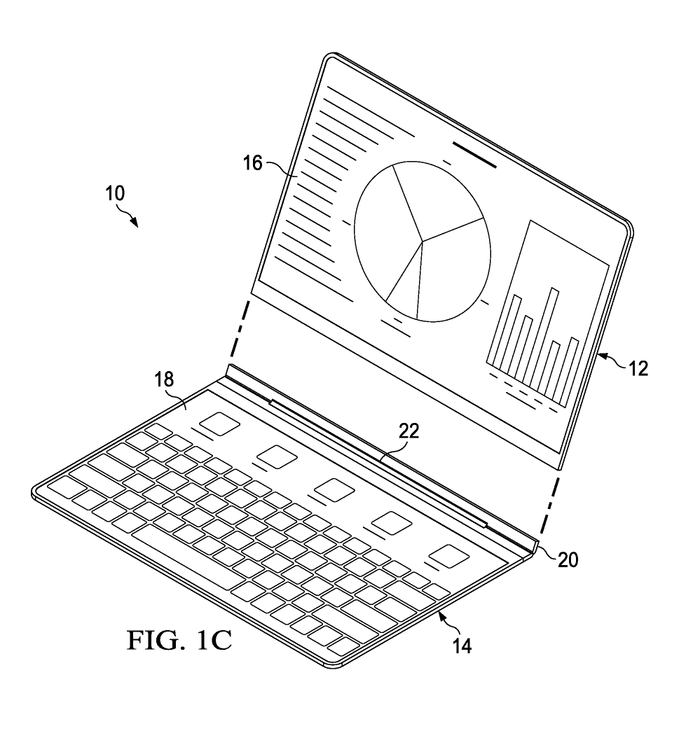

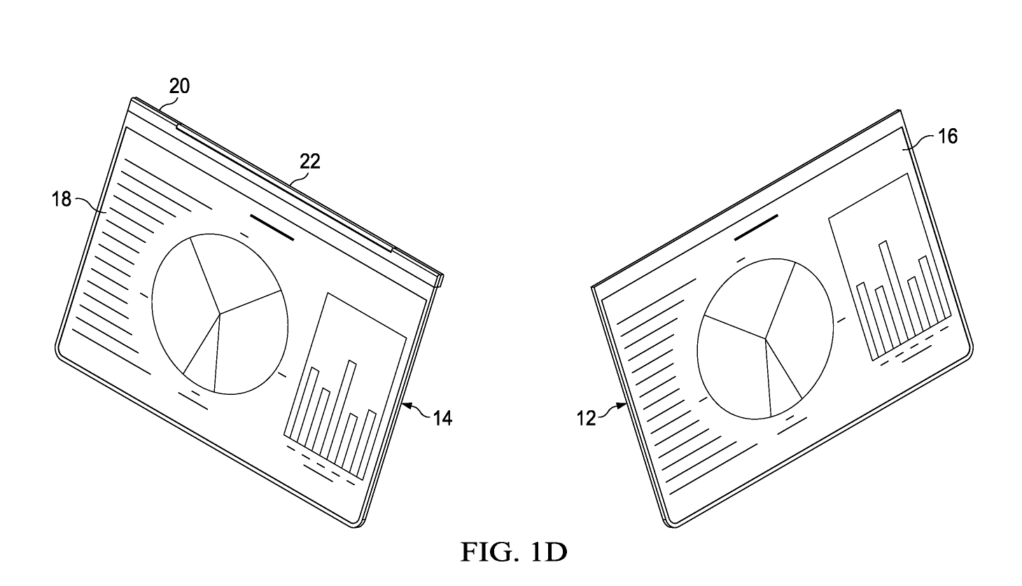

FIG. 1A is a simplified orthographic view illustrating an embodiment of an electronic device 10 in a closed clamshell configuration in accordance with one embodiment of the present disclosure. Electronic device may include a first portion 12, a second portion 14, and a hinge 20. Hinge 20 can define an axis of rotation that is shared between first portion 12 and second portion 14. In an embodiment, hinge 20 can rotate up to three hundred and sixty degrees (360°) or approximately 360°. Hinge 20 can include interconnector 22. Interconnector 22 may be a printed circuit board (PCB) interconnector that can electrically connect first portion 12 to second portion 14.

Tablet and other electronic devices on the market today provide a limited and cumbersome sharing and collaboration environment. Typically, special aftermarket software should be installed and manually configured and activated in order to enable collaboration across two displays (or screens). Further, most tablets available on the market today provide the application object area and the keyboard on the same viewable display. Thus, the software keyboard occupies half of the display real estate; substantially diminishing the viewable application area. In addition, tablet devices on the market today require special cases or add on hardware, such as keyboards, to enable the display to be placed in an upright, vertical, or laptop position.

Electronic device 10 can be configured to provide two displays that, whether physically attached or detached, can facilitate the sharing of content and allow for collaboratively editing content without additional software or effort to activate the collaboration session. In an embodiment, electronic device 10 provides two displays connected with a 360° hinge that enables electronic device 10 to function in a laptop configuration, a tent configuration with each display facing outward, a flat configuration with each display facing upward, a tablet configuration, or other configurations that facilitate a collaborative session. Further, when the two displays are attached, electronic device 10 can provide the capability to utilize one of the attached displays as a full QWERTY keyboard. When the two displays are detached, each display can function as a tablet and the tablets can automatically establish a sharing session to enable collaboration. In an embodiment modifications, changes, edits, annotations, etc. made on one display can be reflected on the other display or cause an action to occur on the other display (such as in a gaming environment). This brings improvements in the user experience with respect to collaboration as electronic device 10 can establish collaborative sessions seamlessly. Electronic device 10 may be used in a business environment, in an education environment (both public and private for one-on-one sessions with students using flash cards or Q&A learning techniques), or in a gaming environment.

In one or more embodiments, electronic device 10 is a notebook computer, laptop, cellphone, a tablet computer and/or a tablet device (e.g., i-Pad), a personal digital assistant (PDA), a smartphone, an audio system, a movie player of any type, a computer docking station, or other device that includes a circuit board coupled to a plurality of electronic components (which includes any type of components, elements, circuitry, etc.). First portion 12 and second portion 14 can each contain a battery and various electronics (e.g., processor, memory, etc.) to allow first portion 12 and second portion 14 to operate as a standalone tablet. In another embodiment, first portion 12 and second portion 14 each contain a wireless module (e.g., Wi-Fi module, Bluetooth module, any suitable 802 protocol, etc.) that allows first portion 12 and second portion 14 to communicate with each other when first portion 12 is removed from second portion 14. First portion 12 and second portion 14 may each include a camera, a microphone, and speakers.

Turning to FIG. 1B, FIG. 1B is a simplified orthographic view illustrating electronic device 10 in an open clamshell configuration in accordance with one embodiment of the present disclosure. First portion 12 may include a first display 16 and second portion 14 may include a second display 18. First display 16 and second display 18 may each be a liquid crystal display (LCD), organic light-emitting diode (OLED), or some other type of display. As illustrated in FIG. 1B, first display 16 may be configured to display graphics or an interactive image and second display 18 may be configured to display a virtual keyboard.

Turning to FIG. 1C, FIG. 1C is a simplified schematic diagram of electronic device 10 being separated into two segments in accordance with one embodiment of the present disclosure. A mechanical snap-in feature may be used to attach, retain, and detach first portion 12 to second portion 14. In an embodiment, a compression connector may engage interconnector 22 such that an electrical coupling (wired or wireless) is created between first portion 12 and second portion 14. Using interconnector 22, an electrical current and signals can be passed to/from first portion 12 from/to second portion 14 to recharge an on-board battery or capacitor, power any number of items (e.g., display 16, a wireless module, camera, speakers, etc.), and provide a communication path between first portion 12 and second portion 14. In other examples, electrical current and signals can be passed through a plug-in connector (e.g., whose male side protrusion connects to first portion 12 and whose female side connects to second portion 14 or vice-verse). Note that any number of connectors (e.g., Universal Serial Bus (USB) connectors (e.g., in compliance with the USB 3.0 Specification released in November 2008), Thunderbolt™ connectors, a non-standard connection point such as a docking connector, etc.) can be provisioned in conjunction with electronic device 10. [Thunderbolt™ and the Thunderbolt logo are trademarks of Intel Corporation in the U.S. and/or other countries.]. Virtually any other electrical connection methods could be used and, thus, are clearly within the scope of the present disclosure.

Turning to FIG. 1D, FIG. 1D is a simplified schematic diagram illustrating electronic device 10 in a detached configuration, separated into two segments, in accordance with one embodiment of the present disclosure. After being separated (as illustrated in FIG. 1C) first portion 12 and second portion 14 may automatically establish a sharing session to enable collaboration. When first portion 12 is separated from second portion 14, each can operate as a standalone tablet. As illustrated in FIG. 10D, instead of displaying a virtual keyboard, second portion 14 can display the same image that is displayed on first portion 12. This allows for the sharing of content and allows content to be collaboratively edited. For example, changes, edits, or notations on one display (e.g., display 16) could appear on the other display (e.g., display 18). Such a configuration can bring improvements in the user experience with respect to collaboration as collaborative sessions can be established seamlessly.

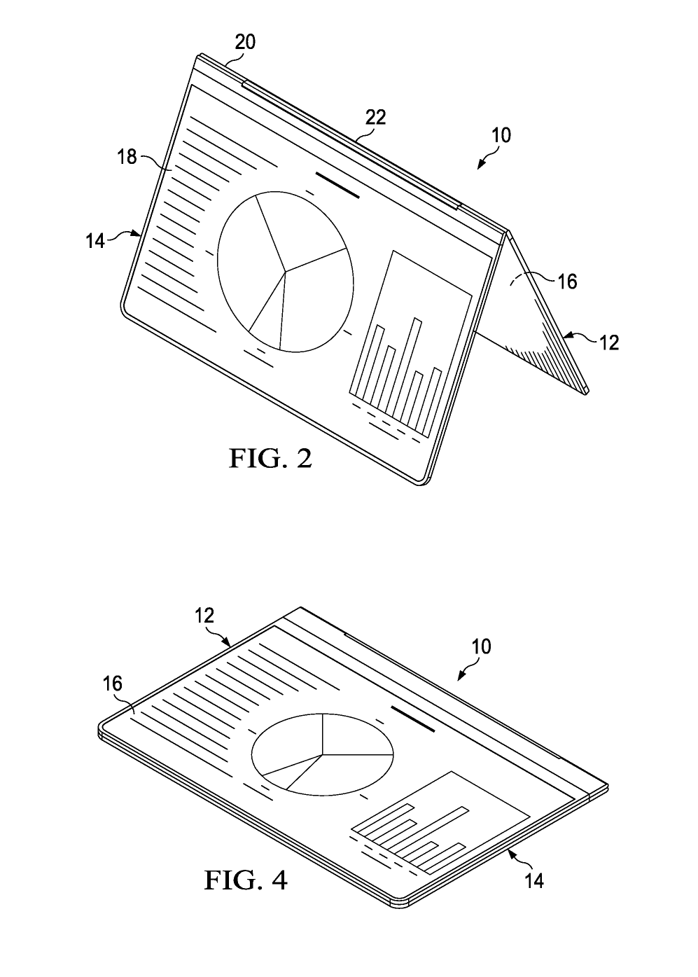

Turning to FIG. 2, FIG. 2 is a simplified orthographic view of an electronic device 10 in accordance with one embodiment of the present disclosure. As illustrated in FIG. 2, first portion 12 has been rotated on hinge 20 past a clamshell configuration into a tent configuration. When in a tent configuration, first portion 12 and second portion 14 may automatically establish a sharing session to enable collaboration. Such a configuration could allow for collaboration while electronic device 10 is resting on a table or some other similar surface. For example, instead of displaying a virtual keyboard, second display 18 may display the same image that is displayed on first display 16 (not shown). This allows for the sharing of content and allows content to be collaboratively edited. Changes, edits, or notations on one display (e.g., display 16) could appear on the other display (e.g., display 18).

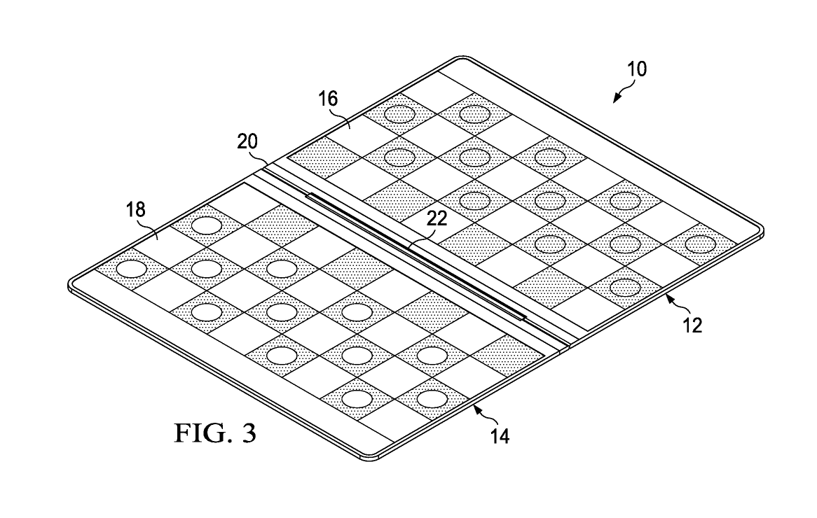

Turning to FIG. 3, FIG. 3 is a simplified orthographic view of an electronic device 10 in accordance with one embodiment of the present disclosure. As illustrated in FIG. 3, first portion 12 has been rotated such that it is parallel with second portion 14. Such a configuration could allow for the sharing of content and allow content to be collaboratively edited or for the playing of a virtual board game or some other virtual form of entertainment. For example, as illustrated in FIG. 3, first portion 12 can display one side of a checkerboard while second portion 14 can display the opposite side of the checkerboard. In an embodiment, (and not limited to the configuration shown in FIG. 3) changes made on one display may not appear on the other display. In addition, one display may react to changes made on the other display.

Turning to FIG. 4, FIG. 4 is a simplified orthographic view of an electronic device 10 in a tablet configuration in accordance with one embodiment of the present disclosure. As illustrated in FIG. 4, first portion 12 has been rotated 360° (or about 360°) over second portion 14 such that electronic device 10 is a tablet computer, a tablet device, or in a tablet configuration.

Hinge 20 and interconnect 22 allows first portion 12 to be attached to second portion 14 and rotated around second portion 14 360°. For example, first display 16 on first portion 12 may face inward towards second display 18 on second portion 14 (as illustrated in FIG. 1A—clamshell configuration or mode) or first display 16 may facing outward away from second display 18 (as illustrated in FIG. 4—tablet configuration or mode). Electronic device 10 can be configured in multiple possible configurations such as a clamshell configuration (both an open and closed configuration), tablet configuration, movie configuration, etc. When electronic device 10 is in a clamshell configuration, the closed position allows for the protection of first display 16 and second display 18. When first portion 12 is rotated up to an open position, electronic device 10 can operate in a traditional laptop orientation (i.e., a virtual keyboard displayed on second display 18 as illustrated in FIG. 1B). When first portion 12 is rotated 360° (or about 360°) and is flipped upside-down to face outwardly in a tablet configuration (as shown in FIG. 4) second portion 14 (and second display 18) may be nested behind first portion 12 and out of the way of user interaction. In an embodiment, second portion 14 can operate as a stand (behind first portion 12) and electronic device 10 can become a stationary display (e.g., movie mode).

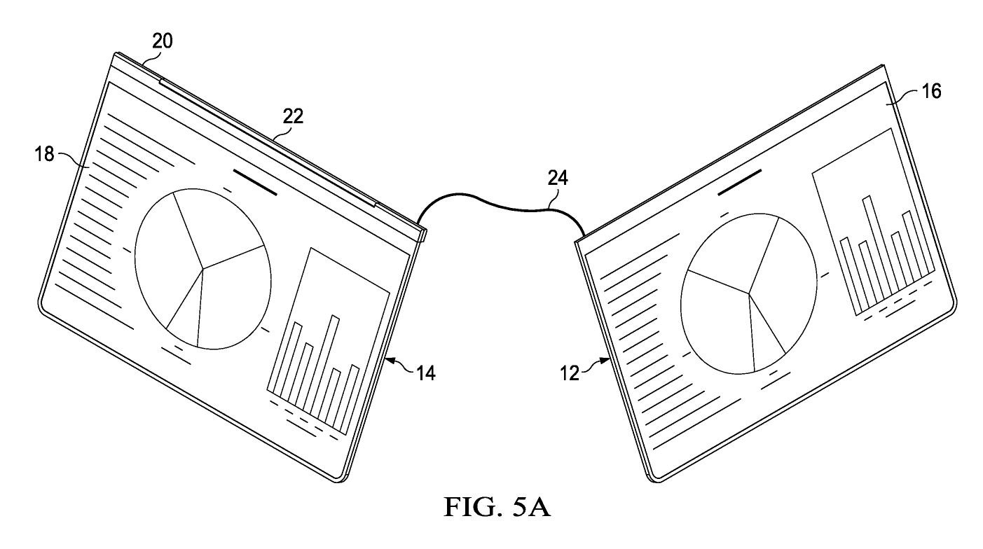

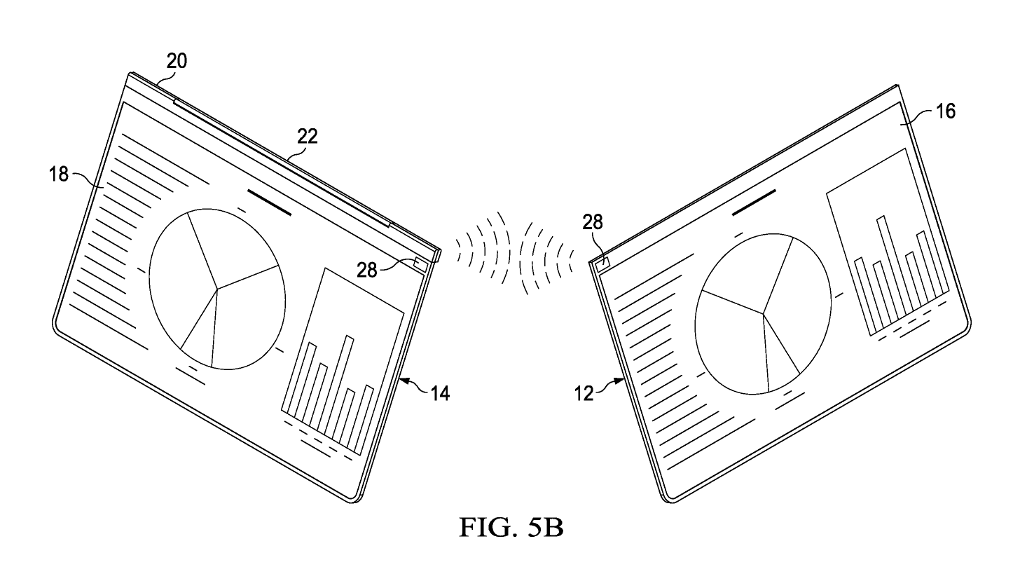

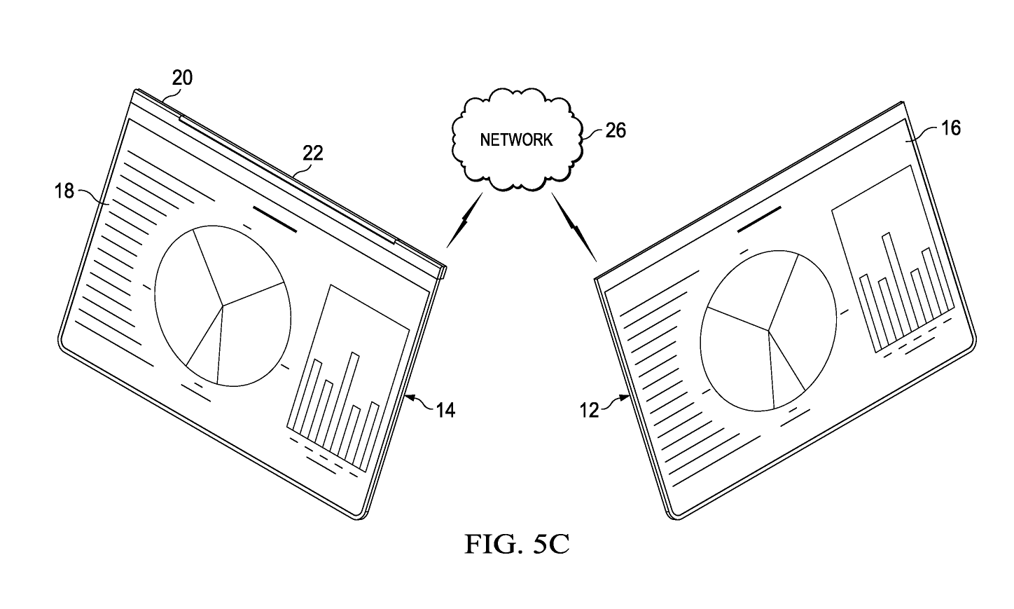

Turning to FIG. 5A, FIG. 5A is a simplified schematic diagram illustrating electronic device 10 in a detached configuration, separated into two segments, in accordance with one embodiment of the present disclosure. When first portion 12 is separated from second portion 14, first portion 12 and second portion 14 may communicate through an electrical connector 24. Electrical connector 24 may be any number of connectors such as a USB connector, category 5 (cat 5) cable, category 5e (cat 5e) cable, Thunderbolt™ connector, a non-standard connection point such as a docking connector, etc. Virtually any other electrical connection methods could be used and, thus, are clearly within the scope of the present disclosure.

Turning to FIG. 5B, FIG. 5B is a simplified schematic diagram illustrating electronic device 10 in a detached configuration, separated into two segments, in accordance with one embodiment of the present disclosure. When first portion 12 is separated from second portion 14, first portion 12 and second portion 14 may communicate through a wireless connection (e.g., a wireless module that interacts with network 26). In an embodiment, the wireless connection may be a wireless personal area network (WPAN) to interconnect first portion 12 and second portion 14 within a relatively small area (e.g., Bluetoothr™, invisible infrared light, Wi-Fi, etc.). In another embodiment, the wireless connection may be a wireless local area network (WLAN) that links first portion 12 and second portion 14 over a relatively short distance using a wireless distribution method, usually providing a connection through an access point for Internet access. The use of spread-spectrum or OFDM technologies may allow first portion 12 and second portion 14 to move around within a local coverage area, and still remain connected to the network and each other. The wireless connection may be any 3G/4G/LTE cellular wireless, WIFi/WiMAX connection, or some other similar wireless connection.

Turning to FIG. 5C, FIG. 5C is a simplified schematic diagram illustrating electronic device 10 in a detached configuration, separated into two segments, in accordance with one embodiment of the present disclosure. When first portion 12 is separated from second portion 14, first portion 12 and second portion 14 may communicate through network 26. Network 26 may be a series of points or nodes of interconnected communication paths for receiving and transmitting packets of information that propagate through network 26. Network 26 offers a communicative interface between first portion 12 and second portion 14, and may be any local area network (LAN), wireless local area network (WLAN), metropolitan area network (MAN), Intranet, Extranet, WAN, virtual private network (VPN), or any other appropriate architecture or system that facilitates communications in a network environment. Network 26 can comprise any number of hardware or software elements coupled to (and in communication with) each other through a communications medium.

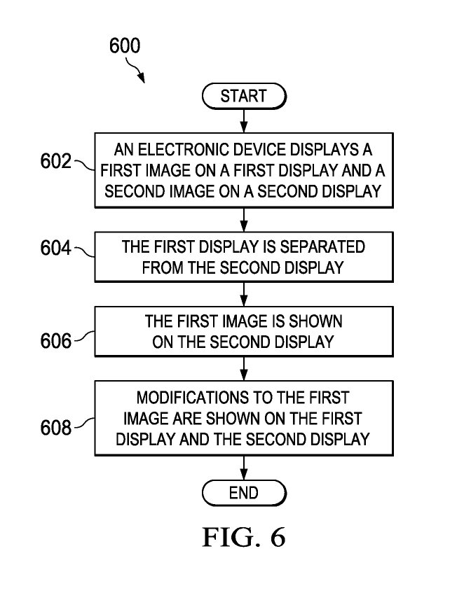

Turning to FIG. 6, FIG. 6 is a simplified flowchart 600 illustrating example activities of a configurable display device system. At 602, an electronic device displays a first image on a first display and a second image on a second display. Each image may be an interactive image that reacts to input from a user. In an embodiment, one image is a virtual keyboard. At 604, the first display is separated from the second display. At 606, the first image is shown on the second display. At 608, modifications (e.g., changes, edits, annotations, etc.) to the first image are shown on the first display and the second display.

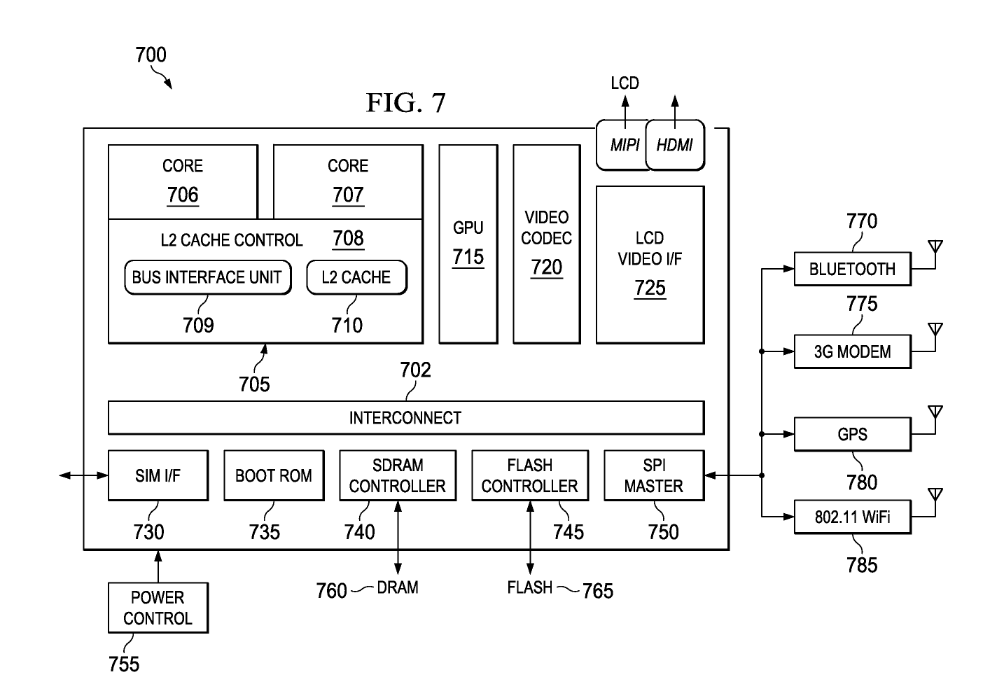

FIG. 7 is a simplified block diagram associated with an example ARM ecosystem SOC 700 of the present disclosure. At least one implementation of the present disclosure can include an integration of the managing connection cost and bandwidth features discussed herein and an ARM component. For example, the example of FIG. 7 can be associated with any ARM core (e.g., A-9, A-15, etc.). Further, the architecture can be part of any type of tablet, smartphone (inclusive of Android™ phones, i-Phones™), I-Pad™, Google Nexus™, Microsoft Surface™, personal computer, server, video processing components, laptop computer (inclusive of any type of notebook), Ultrabook™ system, any type of touch-enabled input device, etc.

In this example of FIG. 7, ARM ecosystem SOC 700 may include multiple cores 706-707, an L2 cache control 708, a bus interface unit 709, an L2 cache 710, a graphics processing unit (GPU) 715, an interconnect 702, a video codec 720, and a liquid crystal display (LCD) I/F 725, which may be associated with mobile industry processor interface (MIPI)/high-definition multimedia interface (HDMI) links that couple to an LDC.

ARM ecosystem SOC 700 may also include a subscriber identity module (SIM) I/F 730, a boot read-only memory (ROM) 735, a synchronous dynamic random access memory (SDRAM) controller 740, a flash controller 745, a serial peripheral interface (SPI) master 750, a suitable power control 755, a dynamic RAM (DRAM) 760, and flash 765. In addition, one or more example embodiment include one or more communication capabilities, interfaces, and features such as instances of Bluetooth™ 770, a 3G modem 775, a global positioning system (GPS) 780, and an 802.11 WiFi 785.

In operation, the example of FIG. 7 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, core processor 705 may implement an out-of-order superscalar pipeline with a coupled low-latency level-2 cache.

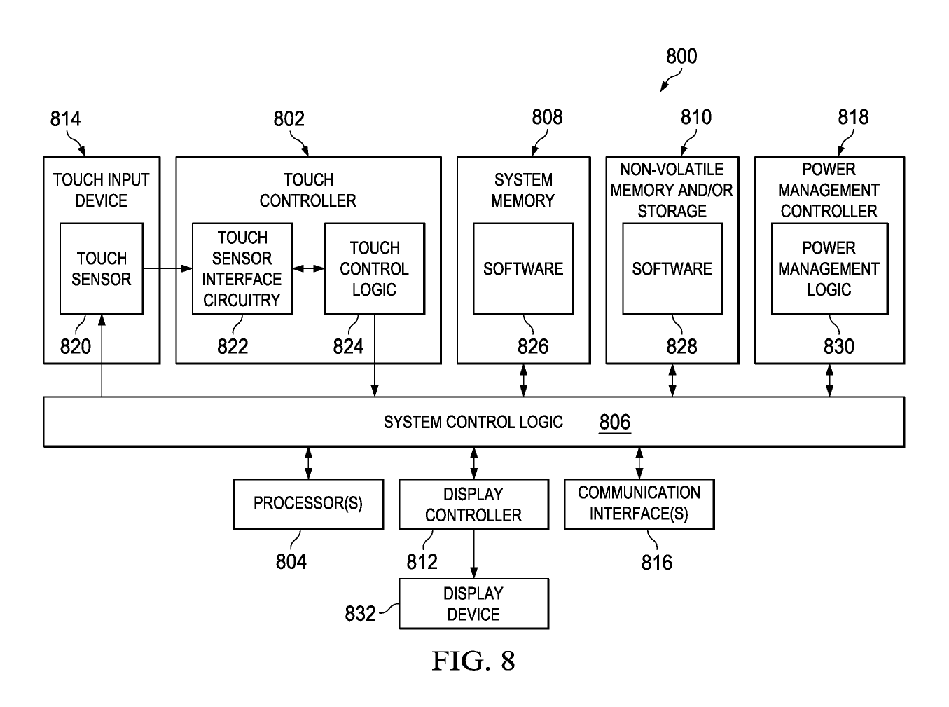

FIG. 8 is a simplified block diagram illustrating potential electronics and logic that may be associated with any of the configurable display operations discussed herein. In at least one example embodiment, system 800 can include a touch controller 802, one or more processors 804, system control logic 806 coupled to at least one of processor(s) 804, system memory 808 coupled to system control logic 806, non-volatile memory and/or storage device(s) 810 coupled to system control logic 806, display controller 812 coupled to system control logic 806, display controller 812 coupled to a display device 832, power management controller 818 coupled to system control logic 806, and/or communication interfaces 816 coupled to system control logic 806.

System control logic 806, in at least one embodiment, can include any suitable interface controllers to provide for any suitable interface to at least one processor 804 and/or to any suitable device or component in communication with system control logic 806. System control logic 806, in at least one example embodiment, can include one or more memory controllers to provide an interface to system memory 808. System memory 808 may be used to load and store data and/or instructions, for example, for system 800. System memory 808, in at least one example embodiment, can include any suitable volatile memory, such as suitable dynamic random access memory (DRAM) for example. System control logic 806, in at least one example embodiment, can include one or more I/O controllers to provide an interface to display device 832, touch controller 802, and non-volatile memory and/or storage device(s) 810.

Non-volatile memory and/or storage device(s) 810 may be used to store data and/or instructions, for example within software 828. Non-volatile memory and/or storage device(s) 810 may include any suitable non-volatile memory, such as flash memory for example, and/or may include any suitable non-volatile storage device(s), such as one or more hard disc drives (HDDs), one or more compact disc (CD) drives, and/or one or more digital versatile disc (DVD) drives for example.

Power management controller 818 may include power management logic 830 configured to control various power management and/or power saving functions or any part thereof. In at least one example embodiment, power management controller 818 is configured to reduce the power consumption of components or devices of system 800 that may either be operated at reduced power or turned off when the electronic device is in a low power configuration. For example, in at least one example embodiment, when the electronic device is in a low power configuration, power management controller 818 performs one or more of the following: power down the unused portion of the display and/or any backlight associated therewith; allow one or more of processor(s) 804 to go to a lower power state if less computing power is required in the closed configuration; and shutdown any devices and/or components that are unused when an electronic device is in the closed configuration.

Communications interface(s) 816 may provide an interface for system 800 to communicate over one or more networks and/or with any other suitable device. Communications interface(s) 816 may include any suitable hardware and/or firmware. Communications interface(s) 816, in at least one example embodiment, may include, for example, a network adapter, a wireless network adapter, a telephone modem, and/or a wireless modem.

System control logic 806, in at least one example embodiment, can include one or more I/O controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one example embodiment, at least one processor 804 may be packaged together with logic for one or more controllers of system control logic 806. In at least one example embodiment, at least one processor 804 may be packaged together with logic for one or more controllers of system control logic 806 to form a System in Package (SIP). In at least one example embodiment, at least one processor 804 may be integrated on the same die with logic for one or more controllers of system control logic 806. For at least one example embodiment, at least one processor 804 may be integrated on the same die with logic for one or more controllers of system control logic 806 to form a System on Chip (SoC).

For touch control, touch controller 802 may include touch sensor interface circuitry 822 and touch control logic 824. Touch sensor interface circuitry 822 may be coupled to detect touch input over a first touch surface layer and a second touch surface layer of a display (i.e., display device 832). Touch sensor interface circuitry 822 may include any suitable circuitry that may depend, for example, at least in part on the touch-sensitive technology used for a touch input device. Touch sensor interface circuitry 822, in one embodiment, may support any suitable multi-touch technology. For example, touch input device 814 may include touch sensor 820. Touch sensor interface circuitry 822, in at least one embodiment, can include any suitable circuitry to convert analog signals corresponding to a first touch surface layer and a second surface layer into any suitable digital touch input data. Suitable digital touch input data for at least one embodiment may include, for example, touch location or coordinate data.

Touch control logic 824 may be coupled to help control touch sensor interface circuitry 822 in any suitable manner to detect touch input over a first touch surface layer and a second touch surface layer. Touch control logic 824 for at least one example embodiment may also be coupled to output in any suitable manner digital touch input data corresponding to touch input detected by touch sensor interface circuitry 822. Touch control logic 824 may be implemented using any suitable logic, including any suitable hardware, firmware, and/or software logic (e.g., non-transitory tangible media), that may depend, for example, at least in part on the circuitry used for touch sensor interface circuitry 822. Touch control logic 824 for at least one embodiment may support any suitable multi-touch technology.

Touch control logic 824 may be coupled to output digital touch input data to system control logic 806 and/or at least one processor 804 for processing. At least one processor 804 for at least one embodiment may execute any suitable software to process digital touch input data output from touch control logic 824. Suitable software may include, for example, any suitable driver software and/or any suitable application software. As illustrated in FIG. 8, system memory 808 may store suitable software 826 and/or non-volatile memory and/or storage device(s).

Note that in some example implementations, the functions outlined herein may be implemented in conjunction with logic that is encoded in one or more tangible machine readable storage media (e.g., embedded logic provided in an application-specific integrated circuit (ASIC), in digital signal processor (DSP) instructions, software (potentially inclusive of object code and source code) to be executed by a processor, or other similar machine, etc.), which may be inclusive of non-transitory media. In some of these instances, memory elements can store data used for the operations described herein. This can include the memory elements being able to store software, logic, code, or processor instructions that are executed to carry out the activities described herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a DSP, an erasable programmable read only memory (EPROM), electrically erasable programmable read-only memory (EEPROM)) or an ASIC that can include digital logic, software, code, electronic instructions, or any suitable combination thereof.

Note that with the examples provided above, as well as numerous other examples provided herein, interaction may be described in terms of layers, protocols, interfaces, spaces, and environments more generally. However, this has been done for purposes of clarity and example only. In certain cases, it may be easier to describe one or more of the functionalities of a given set of flows by only referencing a limited number of components. It should be appreciated that the architectures discussed herein (and its teachings) are readily scalable and can accommodate a large number of components, as well as more complicated/sophisticated arrangements and configurations. Accordingly, the examples provided should not limit the scope or inhibit the broad teachings of the present disclosure, as potentially applied to a myriad of other architectures.

It is also important to note that the blocks in the flow diagrams illustrate only some of the possible signaling scenarios and patterns that may be executed by, or within, the circuits discussed herein. Some of these blocks may be deleted or removed where appropriate, or these operations or activities may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the present disclosure in that any suitable arrangements, chronologies, configurations, and timing mechanisms may be provided without departing from the teachings provided herein.

It is also imperative to note that all of the Specifications, protocols, and relationships outlined herein (e.g., specific commands, timing intervals, supporting ancillary components, etc.) have only been offered for purposes of example and teaching only. Each of these data may be varied considerably without departing from the spirit of the present disclosure, or the scope of the appended claims. The specifications apply to many varying and non-limiting examples and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

### Example Embodiment Implementations

One particular example implementation of an electronic device may include means for automatically facilitating a collaborative session (e.g., using a Wi-Fi connection, a Bluetooth™ connection, a USB connection, etc.) between a first portion of the electrical device and a second portion of the electrical device when the first portion is separated from the second portion of the electronic device. The electronic device may also include means for establishing (e.g., using any type of signal, pathway, port, etc.) a wireless connection between the first portion of the electronic device and the second portion of the electronic device. Further, when the first portion and the second portion are coupled together, the second portion may display a virtual keyboard.

### Other Notes and Examples

Example A1 is an electronic device that includes a first portion that contains a first display; and a second portion coupled to the first portion, where the second portion contains a second display, and when the first portion is separated from the second portion a collaboration session is automatically facilitated between the first portion and the second portion. In Example A2, the subject matter of Example A1 may optionally have the first portion being coupled to the second portion, and the second display displays an interactive virtual keyboard.

In Example A3, the subject matter of any of the preceding ‘A’ Examples can optionally include the first portion being coupled to the second portion by a hinge that can rotate up to approximately three hundred and sixty degrees. The first display and the second display each can comprise a touch display. In Example A4, the subject matter of any of the preceding ‘A’ Examples can optionally allow, during the collaboration session, modifications made on the first display are shown on the second display. In Example A5, the subject matter of any of the preceding ‘A’ Examples can optionally include the first portion is coupled to the second portion by a printed circuit board interconnector.

In Example A6, the subject matter of any of the preceding ‘A’ Examples can optionally include after the first portion is removed from the second portion, the first portion communicates with the second portion using a wireless module. In Example A7, the subject matter of any of the preceding ‘A’ Examples can optionally include the wireless module being a Wi-FI module. Power and data can flow between the first portion and the second portion when the first portion and the second portion are coupled together.

Example M1 is a method that may include establishing an electrical coupling between a first portion of an electrical device and a second portion of the electrical device, where the first portion includes a first display and the second portion includes a second display, and where removing the first portion from the second portion permits the first portion and the second portion to each operate as a standalone tablet device; and initiating a collaboration session when the first portion is removed from the second portion.

In Example M2, the subject matter of Example M1 can optionally include the second display displaying an interactive virtual keyboard. In example M3, the subject matter of any of the preceding ‘M’ Examples can optionally include the first portion being coupled to the second portion by a hinge that can rotate up to approximately three hundred and sixty degrees. The first display and the second display can each comprise a touch display. During the collaboration session, modifications made on the first display are shown on the second display. In example M5, the subject matter of any of the preceding ‘M’ Examples can optionally include the first portion being coupled to the second portion by a printed circuit board interconnector. In example M6, the subject matter of any of the preceding ‘M’ Examples can optionally include, after the first portion is removed from the second portion, the first portion communicates with the second portion using a wireless module.

Example C1 is at least one machine readable storage medium having instructions stored thereon corresponding to logic, at least a portion of which is partially implemented in hardware, the logic configured to: establish an electrical coupling between a first portion of an electrical device and a second portion of the electrical device, where the first portion includes a first display and the second portion includes a second display, and where removing the first portion from the second portion permits the first portion and the second portion to each operate as a standalone tablet device; and initiate a collaboration session when the first portion is removed from the second portion.

Example X1 is a machine-readable storage medium including machine-readable instructions, when executed, to implement a method or realize an apparatus as in any one of the Examples A1-A7 and M1-M6. Example Y1 is an apparatus comprising means for performing of any of the Example methods M1-M6. In Example Y2, the subject matter of Example Y1 can optionally include the means for performing the method comprising a processor and a memory. In Example Y3, the subject matter of Example Y2 can optionally include the memory comprising machine-readable instructions, that when executed cause the apparatus to perform any of the Example methods M1-M6.

1-21. (canceled)

22. An electronic device, comprising:
a first portion that contains a first display; and
a second portion coupled to the first portion, wherein the second portion contains a second display, and when the first portion is separated from the second portion a collaboration session is automatically facilitated between the first portion and the second portion.

23. The electronic device of claim 22, wherein when the first portion is coupled to the second portion, the second display displays an interactive virtual keyboard.

24. The electronic device of claim 22, wherein the first portion is coupled to the second portion by a hinge that can rotate up to approximately three hundred and sixty degrees.

25. The electronic device of claim 22, wherein the first display and the second display each comprise a touch display.

26. The electronic device of claim 22, wherein during the collaboration session, modifications made on the first display are shown on the second display.

27. The electronic device of claim 22, wherein the first portion is coupled to the second portion by a printed circuit board interconnector.

28. The electronic device of claim 22, wherein after the first portion is removed from the second portion, the first portion communicates with the second portion using a wireless module.

29. The electronic device of claim 28, wherein the wireless module is a Wi-Fi module.

30. The electronic device of claim 22, wherein power and data flow between the first portion and the second portion when the first portion and the second portion are coupled together.

31. A method, comprising:
establishing an electrical coupling between a first portion of an electrical device and a second portion of the electrical device, wherein the first portion includes a first display and the second portion includes a second display, and wherein removing the first portion from the second portion permits the first portion and the second portion to each operate as a standalone tablet device; and
initiating a collaboration session when the first portion is removed from the second portion.

32. The method of claim 31, wherein the second display displays an interactive virtual keyboard.

33. The method of claim 31, wherein the first portion is coupled to the second portion by a hinge that can rotate up to approximately three hundred and sixty degrees.

34. The method of claim 31, wherein the first display and the second display each comprise a touch display.

35. The method of claim 31, wherein during the collaboration session, modifications made on the first display are shown on the second display.

36. The method of claim 31, wherein the first portion is coupled to the second portion by a printed circuit board interconnector.

37. The method of claim 31, wherein after the first portion is removed from the second portion, the first portion communicates with the second portion using a wireless module.

38. The method of claim 37, wherein the wireless module is a Wi-Fi module.

39. The method of claim 31, wherein power and data flow between the first portion and the second portion when the first portion and the second portion are coupled together.

40. An electronic device, comprising:
a first portion that contains a first display; and
a second portion that contains a second display, wherein the first portion can be coupled to the second portion such that the electronic device is in a laptop configuration, and wherein the first portion can be separated from the second portion such that the first portion and the second portion can each be a standalone tablet device and the first display and the second display can be used to facilitate a collaboration session.

41. The electronic device of claim 40, wherein during the collaborative session, the first portion communicates with the second portion using a wireless module.

42. An apparatus, comprising:
logic, the logic at least partially implemented in hardware, the logic to:
establish an electrical coupling between a first portion of an electrical device and a second portion of the electrical device, wherein the first portion includes a first display and the second portion includes a second display, and wherein removing the first portion from the second portion permits the first portion and the second portion to each operate as a standalone tablet device; and
initiate a collaboration session when the first portion is removed from the second portion.
